(19) United States
(12) Patent Application Publication
(10) Pub. No.: US 2021/0192428 A1
(43) Pub. Date: Jun. 24, 2021

(54) METHOD, SOFTWARE, AND AN APPARATUS FOR INSPECTION OF SHIPMENTS

(71) Applicant: CONEXBIRD OY, Palokka (FI)

(72) Inventors: Teuvo HEIKKILÄ, Palokka (FI); Janne JUHALA, Jyväskylä (FI)

(73) Assignee: Conexbird Oy, Palokka (FI)

(21) Appl. No.: 16/093,499

(22) PCT Filed: Apr. 13, 2017
(86) PCT No.: PCT/FI2017/050283

§ 371 Date: Oct. 12, 2018

(30) Foreign Application Priority Data
Apr. 15, 2016 (FI) 20165331

(51) Int. Cl. G06Q 10/08; G01H 17/00; G06N 20/00

(52) U.S. Cl. CPC G06Q 10/083; G06N 20/00; G01H 17/00

(57) ABSTRACT

A method and an arrangement for inspecting a means of transportation and/or cargo. Furthermore, the application relates to software and an apparatus for inspecting a transport unit and/or cargo.

In a method according to an embodiment for inspecting cargo during handling, loading or unloading, the cargo is inspected when cargo units are being handled, loaded into a transport unit or unloaded from a transport unit. The cargo is inspected with aid of image data produced on the cargo and the transport unit. The cargo is inspected with aid of vibration data produced on the cargo and the transport unit. The image data and vibration data are analyzed, and on the basis of the analysis, real-time information and feedback is produced.

### SUBJECT MATTER OF APPLICATION

The application relates to a method and an arrangement for inspecting a means of transportation and/or cargo. Furthermore, the application relates to software and an apparatus for inspecting a transport unit and/or cargo.

### BACKGROUND

Goods and products are transported by road, sea and rail transportation, as well as by air freight. Logistics may require using several means when cargo is transported to a desired destination. The content to be transported may be transferred from one means of transportation to another without unloading the content.

The cargo being transported is typically inspected in specific inspection areas. The inspections may relate to the condition of the container or its contents, as well as the control of freight information. The inspections may prolong the transit time in inspection areas.

### BRIEF SUMMARY

It is an aim of the aspects of the disclosed embodiments to intensify and diversify the inspection of means of transportation and/or cargo.

In a method according to one aspect of the disclosed embodiments, for inspecting cargo during handling, loading or unloading, the cargo is inspected when cargo units are handled, loaded into a transport unit or unloaded from a transport unit. The cargo is inspected by using image data produced of the cargo and the transport unit. The cargo is inspected by using vibration data produced of the cargo and the transport unit. The image data and the vibration data are analyzed, and real-time information and feedback are produced on the basis of the analysis.

According to one aspect of the disclosed embodiments, an apparatus for inspecting cargo during handling, loading or unloading comprises a camera for producing image data on the cargo, a vibration sensor for producing vibration data of the cargo, and program means for analyzing image data and vibration data, and for producing real-time information and feedback on the basis of the analysis.

According to one aspect of the disclosed embodiments, learning software for processing cargo inspection data comprises program means for analyzing image data, program means for analyzing vibration data, and program means for producing real-time information and feedback on the basis of the analysis.

### DESCRIPTION OF THE DRAWINGS

In the following, embodiments will be described in more detail by referring to the appended figures, in which

FIG. 1 shows a transport unit according to an embodiment, and its route.

FIG. 2 shows a transport unit according to an embodiment.

FIG. 3 shows a transport unit according to an embodiment.

### DETAILED DESCRIPTION OF THE EMBODIMENTS

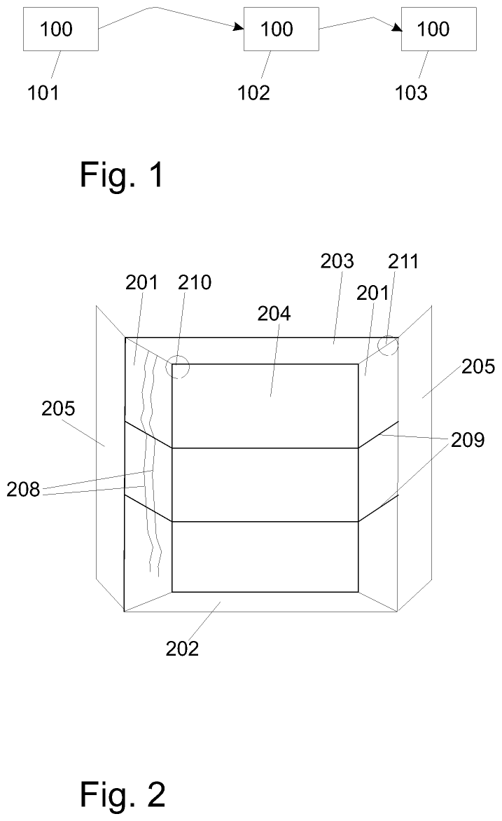

FIG. 1 shows a cargo transport unit according to an embodiment of the invention, and its route. The cargo transport unit 100, or more briefly the transport unit, refers to a unit into which a cargo content is loadable for transportation. The transport unit 100 may be a container, a car, a capsule, a packing, a cargo packing, a tank, a roll-in/roll-off (ro-ro) vehicle, or the like. The transport unit 100 may be moved and handled in appropriate handling and/or storage areas. The handling and/or storage area may be, for example, in a port or in another logistically appropriate location where transport units are handled, stored and/or transferred from or onto a means of transportation. Transport units may be moved by a forklift, a crane, a straddle carrier, hoisting devices, or corresponding means.

In FIG. 1, cargo is loaded in a handling area 101, into a transport unit 100 for transporting the cargo. The cargo may comprise various packaged goods or packaged contents, such as package units. The cargo may be loaded into the transport unit 100 by a handling device, such as a forklift. After the cargo has been loaded into the transport unit 100 in the handling area 101, the transport unit may be stored or loaded onto a means of transportation of cargo. The means of transportation of cargo, or more briefly the means of transportation, refers to a vehicle by which the transport unit 100 may be transported. The means of transportation may be a train, a truck, a ship, an aircraft, or a corresponding vehicle. The transport unit 100 of FIG. 1 is moved by the means of transportation to another handling area 102 of the transport unit 100. In the handling area 102, the transport unit 100 may be stored and/or moved from one means of transportation to another without unloading or reloading the cargo.

From another handling area 102, the transport unit 100 is transported to its destination, to a handling area 103. The transport unit may be transported by land transport, sea transport or air transport. The handling area 103 may be, for example, in a port, from which the transport unit 100 or the cargo contained in it may be delivered to the final destination, to the receiver. The transport unit 100 may be delivered to the destination, to the handling area 103, directly from the place of departure, from the handling area 101, or via several handling areas (102). In a second or another handling area 102 between the place of departure and the destination, it is possible to change the means of transportation or to store transport units 100 and/or cargo. The means of transportation 100 and/or the cargo may be, for example, transferred from a train onboard a ship, or from one ship to another, either directly or via storage.

Transport units may be moved upon handling, during loading, during unloading, for storage, or in corresponding situations. Typically, transport units are handled or moved in dedicated transport areas. A transport unit and the cargo contained in it may be inspected in the handling area, for example upon handling the cargo or the transport unit, upon loading the cargo into the transport unit, or upon unloading the cargo from the transport unit, upon moving the transport unit, upon loading the transport unit onto a means of transportation, upon unloading the transport unit from a means of transportation, or upon storing the transport unit. In the inspection, the condition, state, properties of the transport unit and/or the cargo, as well as changes in these may be inspected.

FIG. 2 shows a transport unit according to an embodiment. FIG. 2 shows the example of a container which may transferred into a means of transportation, such as a train, a truck, a ship, or an aircraft, for transportation. A structure corresponding to that shown in FIG. 2 may also be a trailer for a truck, a railroad car or a corresponding structure having side walls 201, a lower wall 202, an upper wall 203, a rear wall 204, and an openable front wall 205, via which the loading and unloading take place. The transport unit may differ from that shown in FIG. 2. The transport unit may, for example, have a different shape, or a part of it may differ from that shown in FIG. 2. For example, the upper wall may be openable as an alternative or in addition.

The transport unit of FIG. 2 may be inspected when empty. In this way, information is obtained on the applicability of the transport unit for transportation. The applicability of the transport unit for transportation may relate to the condition of the transport unit, the cargo to be transported, the means of transportation, the recipient of the cargo, the destination, or another factor. If defects are found in the applicability of the transport unit, such as in its condition, cleanliness or disinfection, the transport unit may be found inadequate for transportation or for a given shipment. An inadequate empty transport unit is not prepared or loaded, but it is directed to appropriate handling on the basis of the inspection. On the basis of the inspection, the transport unit may be directed, for example, to transportation of different cargo or to transportation to another destination, to be washed, repaired, disinfected, disposed of, or the like.

The transport unit may be inspected by inspection devices. For example in FIG. 2, one or two inspection devices may be placed in a top corner of the transport unit so that one or more inspection devices are attached to the front corner 211 of the interior of the means of transportation, close to the junction of the top wall 203, one of the side walls 201, and the front wall 205. The inspection device 211 may be fastened in a detachable way so that the opened front wall 205 of the transport unit cannot be closed when the inspection device 211 is attached. In addition or alternatively, one or more inspection devices may be attached to a rear corner 210 of the interior of the means of transportation, close to the junction of the upper wall 203, one of the side walls 201, and the rear wall 205. In addition or alternatively, inspection devices may be attached to other points on the transport unit.

The inspection device may be an imaging device, such as a camera, for producing image data of the transport unit. The inspection device may be a vibrating sensor, such as an acceleration sensor, for producing vibration data on the transport unit. The inspection device may be an odour sensor, such as an electronic nose, for producing odour data on the transport unit or its environment. The inspection device may be a device carried by a user, for inspecting a desired point or location of the transport unit or cargo. The inspection devices may be battery-operated. For example, a camera of a portable smart device may be used to image a desired point. The image may be taken in such a way that the identifier or identification data of the cargo unit, such as a package unit, are visible in the image. The smart device may also comprise a reader for a bar code or a corresponding code, whereby the cargo unit may be identified by using the reader. From the smart device, the information may be transmitted further, for example to software, a processing device, or a storage medium. The user's portable device may be used to image specific points in more detail on the basis of the data under review or a visual observation.

Several inspecting devices produce data from different locations and/or different sides of the transport unit. Various inspecting devices produce different types of data. Different inspecting devices may be placed in the same and/or different locations. The different inspecting devices and the different data produced by them may be used to secure and verity observations of inspections devices on the respective locations. Furthermore, the different inspecting devices produce different data in response to different observations and indicate different things which may not necessarily be observed by another inspecting device. Using different inspecting devices, versatile data on the object under review and its environment are obtained.

After an empty transport unit has been inspected and found to be adequate for transportation, it may be prepared to receive a specific type of cargo. The preparation stage is an optional stage. The preparation is made if necessary. The need for preparation and the selected preparatory measures may be selected and defined on the basis of, for example, the cargo to be transported, the packings, the destination, the means of transportation, one or more means of transportation and/or means of handling, the recipient and/or the use of the cargo, another corresponding factor, or a combination of these.

The transport unit of FIG. 2 has been prepared. Ropes 208 are connected to the upper edge of the side walls 201 for lashing the cargo loaded in the transport unit, for transportation. Horizontally extending straps 209 may be placed along the side walls 201 or the rear wall 203 of the transport unit, for lashing the cargo loaded in the transport unit, for transportation. Protective material may be placed on the lower wall 202, i.e. the floor, of the transport unit. The protective material may comprise paper, paperboard, plastic, or other material suited to the need for protection.

The preparations made for the transport unit, such as installing straps on the side walls and/or placing a shield on the floor, are recorded in the data of said transport unit. The data may be stored centrally, for example in a cloud service, where they are available at the place of departure, during loading, during storage, in the handling areas, at the destination, for the receiver, for the shipper, and for other parties. The condition and functionality of the preparations and the preparatory means may also be reviewed and monitored in connection with the inspections of the transport unit.

After the empty transport unit has been inspected and found adequate for transportation, it may be loaded with cargo either immediately or after possible preparation. The condition and/or position of the cargo, the cargo unit, the cargo content, and its packing or wrapping, as well the transport unit and means installed in it during possible preparation, may be inspected and monitored during loading. The loaded transport unit and the cargo may be inspected during its transfer, handling, unloading, transportation, and/or storage. The inspecting device may be placed in the transport unit, a device for handling cargo, a device for handling the transport unit, a means of transportation, a storage, a handling area, or a corresponding location where/whereby the transport unit and/or cargo is loaded, unloaded, handled, transferred, or stored. The inspecting device may be a mobile device for inspecting a desired point or location.

The transport unit and/or cargo shown in FIG. 1 may be inspected before loading of the cargo, during loading the cargo into the transport unit, during unloading the cargo from the transport unit, during storing the transport unit, or during loading the transport unit onto a means of transportation in the handling area 101. The same transport unit and cargo may be inspected by corresponding and/or different inspecting devices in another handling area 102, to which it has been transported. In the handling area 102, the transport unit and the cargo may be inspected at corresponding handling stages when it is handled or, for example, transferred to an intermediate storage and/or to another means of transportation. In a corresponding way, the same transport unit may be inspected in the handling area 103 to which it has been transported. In the handling area 103, the transport unit and/or cargo may be inspected when the transport unit is being transferred from the means of transportation, to an inspection point or a storage in the handling area, or when the cargo is being unloaded from the transport unit. The content to be transported, its quality, recipient, or destination, may have effect on the inspections, such as the number and nature of inspections, as well as the inspecting devices.

The data observed by the inspecting devices is stored centrally, and the data of the inspected transport unit/cargo is available i.e. for the shipper, at the destination, and at each inspection point. For example, the recipient may influence the items to be inspected and their limit values, by recording data centrally. The recorded data is available in the handling areas before arriving at the recipient. The recipient may also monitor the condition, changes and developments by using the recorded data. On the basis of the recorded data and other data available, the system may propose a route, actions, a method or means of loading, for example. The measures taken, the devices used, and other data are recorded in the system and may be monitored.

### Odour Data

In an embodiment, the device for inspecting a transport unit and cargo is an electronic nose or an artificial nose. By the electronic nose, odours and odour data are detected and may be identified. The electronic nose is applicable for inspecting an environment and a closed area, such as the inside of a transport unit or the inside of a storage. The electronic nose may be used to detect a source of odour e.g. in a transport unit, its preparation materials, cargo content, cargo packing, the handling area, or the storage. The electronic nose may be installed stationary or detachably in a handling area, in a transport unit, handling devices, or means of transportation. The electronic nose may be detachably installed in a handling area, on a handling device or in a transport unit for the time of loading and/or unloading of cargo.

The electronic nose may comprise sensors for detecting odours or odour molecules. Odours may generate a physical change in the sensor. Chemical substances detected by the electronic nose are detected by the sensor of the electronic nose. The sensor may react with odour molecules on the basis of e.g. absorption or adsorption, or chemically. The sensor may comprise optical sensors, piezoelectric sensors, metal oxide sensors, conductive sensors, conductive polymer sensors, chemical reactive sensors, acoustic wave sensors, surface acoustic wave sensors, quartz microbalance sensors, or a hybrid sensor utilizing selected sensor techniques. The signal detected by the sensor is converted to digital format and transferred to a digital data processing device, such as a computer device. The data processing device may comprise means for storing data, as well as a processing device and/or a processing unit for data processing. The data processing device may comprise or have access to reference values or models which are used for identifying odour data.

Dangerous gases and harmful contents of them are detected by the electric nose. Certain odours may be classified to be harmful and they may be detected. From the odour data, the source of odour may be identified. Odour emanating from harmful gases, chemicals or corresponding substances may be detected, and the detected odour trace may be stored in the system. The odour may be detected by the sensors of the electronic nose. By means of the odour data it is possible to obtain information about detecting, for example, odour emanating from a substance classified as harmful. Substances detectable and identifiable on the basis of odour data may include, for example, nitrogen oxides, carbon oxides, and hydrogen sulphides.

Odour data and/or the source of odour data may be identified by means of, for example, reference values or other distinctive features. Furthermore, it is possible to estimate the quantity, i.e. the content of odour molecules in the location or space of detection, or a momentary number of odour molecules. The content of gases in a space or in the air changes fast as a function of time. For certain substances, exceeding a detected threshold value may indicate the amount of an odour emitting gas or substance in a space.

Odours in the transport unit, in the cargo contained in it, in the handling area, and/or in its vicinity may be detected, identified, analyzed, classified, and processed by the electronic nose and its processing unit. An odour may be imparted to the cargo e.g. from the cargo packing, the means of transportation, the storage, or because of a situation/conditions prevailing on the route. For example, particles, such as soot or flue gases, may be entrained in the air close to the storage area and imparted to the cargo. By means of odour data detected by the electronic nose, the system detects the odour in the handling area and can indicate that said cargo is at risk of being rejected because of the odour detected. The system is capable of identifying the source of odour on the basis of, for example, the location, the moment of detecting the odour data, and possible other factors. In this way, information on an inadequate handling area is obtained, and it is possible to avoid bringing cargo to the inadequate handling area and subjecting it to undesired odour. The detected odour may be classified as unpleasant or harmful. Dirtiness of the transport unit, the handling area or its vicinity may impart odour which is detected by the electronic nose. For example, the transport unit may be disinfected. The disinfectant may contain gas or pesticide. Limit values are set for the contents of disinfectants to be used in the transport unit. Exceeding the limit values may be detected by the electronic nose. On the basis of the detected odour data and its analysis, it is possible to avoid loading of cargo into the transport unit in vain when it is known that the recipient would not accept the transported cargo on the basis of the detected odour data and its analysis. The need for washing the transport unit or the environment may be determined, and the transport unit or the cargo may be replaced on the basis of the detected and analyzed odour. Odour emanating from the cargo or its packing material may be detected by the electronic nose. The detectable odour may change during the handling, transportation or storage of the transport unit. The odour may be identified or it may be classified as unknown. The detected odour may also be a combination of known and unknown.

For identifying odours, the system may be taught. In addition to certain odours which are identifiable and, for example, classified as harmful, the system may be taught to detect odours on the basis of, for example, opinions, definitions, certificates, or observations. Certain odour data may be defined or classified as unpleasant/pleasant, acceptable/unacceptable, adequate/inadequate for the system. The definition or classification may be user specific. The definition/classification may be based on user observations, preferences, the use of the product, or another corresponding factor. The system stores the odour data and its user specific odour data classification or definition. The system learns from the data entered into it and on the basis of data processed by it as well as user specific entries. The system may analyze, identify and classify odour data according to a given recipient or cargo type. The system is capable of looking for correlations between odour data and other factors. The system may identify and determine variables relating to odour data, such as a certain area or location, a certain manufacturer, a certain material. From these, the system may conclude and learn, for example, definitions/classifications relating to a certain area or location, definitions/classifications relating to a certain recipient, definitions/classifications relating to certain odour data, definitions/classifications relating to a certain cargo, the analyses needed or factors effective on certain detected odour data. The system may associate the odour data and classification with other factors which, at a given probability, are related to said classification and/or odour data on the basis of the entries received by the system and analyses made by the system. The system may learn from the available data by analyzing it, for example by calculating probabilities. Artificial intelligence may be used to combine multidimensional data and to find interdependencies between various factors. The system may be used to determine and/or produce an odour certificate which may be utilized by the system in analyzing odours. The odour certificate may define certain limit values to assure a given quality.

At the destination of the cargo, the recipient may classify certain odours as unacceptable or unfit for a given purpose. The recipient specific (odour data) classification may be based on the use, the handling of the cargo, and/or the recipient's opinion. For example, for cargo to be supplied to food industry, there may be precisely defined specifications, definitions and reference values for the quality of the cargo. For example, the odour of mould in the cargo may be sensed, and contaminated cargo may be detected. Moulding of cargo may be due to a packaging defect, the transport time or transport conditions on the route. It is also possible that there is no given reason for the contamination. Manufacturing or packaging material or product may be delivered as cargo. In addition to predetermined and known reference values, it is possible to define unacceptable or inadequate odour data or odour values for the cargo, according to local preferences. For example, the packing of a food product to be sold in a street kitchen is brought close to a consumer's nose, whereby a packing odour sensed as unpleasant will affect the sale of the food product. Data on such sensory classification by the end user may be entered as part of the inspection data for inspecting the transport unit and the cargo. The data is immediately available up at the beginning of the transportation chain as well. In this way, the recipient specific odour data classification may be updated and available in real time, and it may be immediately taken into account at each stage. An unaccepted or inadequate cargo or transport unit will not be used but will be replaced with another. In this way, transportation time and costs are saved when unaccepted cargo is not transported in vain.

The acceptability of the odour may depend on the use, the recipient, the preferences, or the destination. Odour that is unacceptable to the recipient may emanate from the transported product. For example, the use of recycled materials may cause unacceptable odour. One example is plastic and rubber products, such as used car tyres; the products made from them are suitable for outdoor use, but for example as a material for a cushion to be brought indoors they may cause unacceptable odour in said room. The washing of the transport unit may remain incomplete; for example, oil may be left on the floor. This may cause unacceptable odour to the content to be transported, and also damage the content, if the oil or other dirt comes into contact with the freight content. There are local differences in odours to which people are accustomed, and an odour which is acceptable in one area, for example in Asia, may be defined unacceptable in another area, for example in Europe.

Cargo quantities are often large, and preparations are made to deliver cargo to the recipient at the destination (FIG. 1, 103) within even a short time from the order. Transport units may be placed in intermediate storage (FIG. 1, 102) close to the destination (FIG. 1, 103) so that they may be delivered to the recipient at the destination (FIG. 1, 103) faster from the intermediate storage (FIG. 1, 102) than from the original point of departure (FIG. 1, 101). The inspection data contains data detected in inspections at different stages of transport and handling. The inspection data may be used to detect a location or a factor playing a role in an undesired end result. When data about unacceptable cargo, on the basis of odour, is stored as a part of the inspection data, the source of the odour may be located and/or identified, for example at a given probability. The system may detect, for example, where the odour data comes from and/or where the unacceptable odour data was found for the first time. The system is capable of concluding the source of the odour. For example, odour data on the end product, classified as unacceptable, may come from the freight content, such as the product or its packaging material, the packaging material of the cargo, the transport unit, means placed in the transport unit during the preparation, the means of transportation, the transportation or storage, or a change caused during the handling. On the basis of the observations and analyses, the system may suggest a remedy or measures to improve the situation. On the basis of this, the problem may be remedied, and transport units classified as unacceptable will not be transported in vain to the intermediate storage either.

Remedying the problem will depend on the source of the odour, and it may involve removing a localized source of odour, replacement or remedying of the source of odour, washing or disinfecting of the transport unit, changing the cargo or its packing, replacing the means used for preparations, replacing the location or method of storage, inspecting the handling area, replacing the means of transportation, replacing the loading device, changing the route, taking into account the season of the year, or giving instructions for handling phase, loading phase or unloading phase.

In an embodiment, the cargo to be transported may be packed in a gas packing. The cargo is packed, for loading, by wrapping the cargo unit to be loaded, at least partly with packing material. Several packed cargo units are loaded in one transport unit. The packing material contains an identifiable gas between two layers impermeable to gas. The packing gas in the gas layer is a known harmless gas detectable by sensors. At the inspection stages, the electronic nose will detect and identify the packing gas. A quick increase in or a high level of the gas content is entered in the inspection data. Packing gas is detected if the layer impermeable to gas is damaged and gas is leaked into the air. Detecting the packing gas indicates a damage in the cargo or at least its packing. A more precise inspection may be appropriate if packing gas is detected by an electronic nose during the inspection. The observation is entered in the system and is available and processable in real time. The electronic nose or its sensors may be selected in such a way that the electronic nose is sensitive to even small contents of said packing gas. The electronic nose may be placed in a transport unit, such as a container. In addition or alternatively, the electronic nose may be placed in a forklift and/or a storage space. In this way, it is possible to collect data and monitor the integrity of the gas packing during transport, handling and transfers. If damage of the packing is detected, the location and possible cause of the damage may be estimated on the basis of the detected and/or entered inspection data. For example, the moment of time corresponding to the odour detection may be checked from camera data, for obtaining additional information.

According to one aspect of the invention, the learning system and electronic nose are integrated in logistics, such as container logistics. By means of the electronic nose, it is possible to detect odour data emanating from the means of transportation and/or cargo, and to analyze it by the system which may include a learning system, program means and/or a processing device. The system identifies toxic gases and, for example, gases typical of a given packing. The system may, for example, detect damage of a single cargo packing on the basis of a gas added to it or specific to it. For example, toxic gases are identified, and dangerous packings are not transported but their transportation may be prevented. Furthermore, the odour data is classified as acceptable/unacceptable, adequate/inadequate on the basis of a recipient specific classification. Recipient specific preferences may relate to a location, a use, preferences, end use, cargo type, and so on. By means of the system, the odour data may be classified, for example allowable/unallowable, acceptable/unacceptable, adequate/inadequate. In a corresponding way, on the basis of analyzed odour data, the cargo and/or the means of transportation is classified as acceptable/unacceptable. The classification may be implemented, for example, for a different cargo type or according to the recipient. In the classification, a number of variables may be used which influence the classification. On the basis of the odour data of the means of transportation, the means of transportation may be directed to being washed or being used for a given cargo, even if it were not suitable for a different cargo on the basis of the odour data. In this way, the shipments and the use of means of transportation may be made more efficient. For example when the recipient is food industry, the odour data of the means of transportation and the cargo has a different classification and classification basis than odour data of recycled materials, for example.

Odour data classifications may be set up by means of the learning system on the basis of entries and analyses. The entries may be made by a given entity, or they may come from inspections. The entries may be associated with a recipient, a destination area, such as a country or continent, a use, a cargo type, a means of transportation, a route, a season, a weekday, a month, a time, a packaging method, a handling device, weather history, weather data, weather forecasts, or any known history data or predictable data. On the basis of history data it is known, for example, that a given floor material on a given route causes unpleasant odour in a given season, which may cause rejection of the cargo at the receiving end. In this way, said route may be avoided in said season, as proposed by the system. Versatile data may affect the odour data classification, and the classification may depend on a number of factors. The system will learn from the data entered in and processed by it. By means of artificial intelligence, raw data may be analyzed and used to find factors affecting odour data. Instead of or in addition to raw data, a part separated from the data may be analyzed.

Using the electronic nose, odour data may be detected in logistics solutions and utilized for evaluations and inspections. On the basis of the odour data, an inadequate or unacceptable object may be removed or replaced immediately, and the transport resources are not used in vain. It is possible to prevent transferring damaged cargo to a means of transportation or a handling area. On the basis of the odour data, it is possible to prevent transferring cargo to an unacceptable means of transportation, transport area or storage. The odour data may indicate factors which cannot be observed otherwise, by using other inspection devices or other inspection data.

### Image Data and Vibration Data

At the same or corresponding locations and stages as those described above for detecting odour, it is possible to use one, two or more cameras for producing image data, and/or one, two or more vibration sensors for producing vibration data. Cameras and/or vibration sensors and inspection devices may be placed in a number of locations which may be the same as and/or different from the locations where electronic noses are placed in corresponding spaces and devices. Image data and vibration data may be produced of an empty transport unit, the stage of preparing a transport unit, a prepared transport unit, the stage of handling, loading or unloading a transport unit, a partly and fully loaded and/or unloaded transport unit, as well as cargo or cargo units to be loaded or already loaded.

With two or more cameras, image data may be obtained from different directions. The camera may be movable, whereby one camera may be used to image different places and from different directions. Camera data may be used to record visible and invisible light, such as infrared light. The camera may be a hyperspectral camera. Shooting with several cameras, data may be obtained from all sides of the cargo unit.

Image data of the camera may be used to inspect that an empty transport unit is in suitable condition for use. For example, it is detected from image data if nails are sticking out of the floor level of the means of transportation, if there is garbage or dirt on the floor, or if the floor is damaged, the lashing rings are damaged, or if there are discontinuity points, dents or other damaged points on the walls. A prepared container may be inspected, and the image data may be used to detect and make sure that the protective paper on the floor surface is straight and in place, the protective cardboards on the walls are in place, a sufficient number of lashes is provided and fastened to the desired points, and so on.

The packing material used for the cargo or cargo unit may be material comprising two or more layers in such a way that the difference between the layers is visually detectable. By means of image data, it is possible to detect the exposure of an inner layer if an outmost or another packing layer is damaged. This indicates damage in the packaged cargo or at least in the packing of the cargo. The difference between the packing layers may be detected as a colour difference. Underneath a surface layer, the packing layer may contain a packing layer of a different colour or a reactive substance. The reactive substance may react with the environment, such as oxygen, carbon dioxide or light, after the surface layer has been damaged. Upon reacting, the reactive substance may change its colour. In this way, the damage point is detected from the image data at the inspection stages and/or points.

The packing material of the cargo or cargo unit may contain surface textures, on the basis of which the position of the cargo unit may be verified, for example from image data. The packing material, the outer surface of the packed cargo unit, may be equipped with a pattern, a product label, codes, bar codes, or the like. The pattern may, for example, encircle the packing in the horizontal direction. The patterns are detected in the image data and may be used to verify the position of the cargo unit. For example, a deviation of a horizontal pattern from the horizontal direction in the image data indicates a slanted position of the cargo unit. This may be due to, for example, the fact that the cargo unit is placed in an incorrect location on the lateral support of the transport unit, or a corresponding piece, or that a bedding material placed during preparation has been crumpled under the cargo unit. A slight error in the position of the cargo unit placed on the floor of the transport unit may be multiplied in the cargo units loaded on it. This may cause a danger during the transport. Without the image data and the real-time feedback from it in the loading situation, the position error may be detected first after it has multiplied in the cargo units on top of it. At this stage, a correction will require the unloading of several cargo units loaded on top of each other. Detecting and indicating the position by the image data in real time makes it possible to remedy the problem at once and in a targeted way.

The inspection device may comprise a vibrating device, for example a vibrating sensor or acceleration sensor. The vibrating device may be used to generate vibration in the transport unit, to be measured. In this way, the empty transport unit may be inspected by means of vibration data. A damaged, broken or deformed transport unit vibrates differently from an intact transport unit. The vibration sensor may detect and generate vibration data in three different directions, for example along three transverse axes (xyz).

The vibration device may be used to measure vibration generated in the transport unit during, for example, loading and unloading, or handling. In the inspection, it is possible to apply vibration caused by the kinetic energy of the handling device on the transport unit. The detected intensity of vibration may be measured. For example, a momentary peak in the measured vibration data indicates a possible time of collision during handling, loading or unloading. When the time is known, image data around said time may be viewed. In this way, one knows to look at the relevant image data, from the relevant moment of time. It is not necessary to analyze or view all image data with equal precision.

After the cargo units have been loaded, entirely or in part, in the transport unit, the vibration data indicates whether the cargo units have been placed tightly and/or if they, for example, hit the side walls of the transport unit. By means of the vibration device, it is possible to determine the position of the transport unit, the cargo or the cargo unit in relation to the ground, in the direction of gravity. By means of the straps installed during the preparation, the loaded cargo units may be tied together in the transport units. The quality of the lashing and the loading may be inspected by using the vibration data of the vibration device and the image data of the camera. From the vibration and/or image data, it may be detected if a gap has been left between the cargo units or if they are tightly together or if the straps or lashing cords are tight. A gap left between the cargo units or slackness left in the lashes will cause vibration different from that caused by cargo units packed tightly and tied with tight lashes/cords. For example in the case of cargo units of different sizes loaded on top of each other, the smaller ones on top may move in the lateral direction. They vibrate in differently from tightly packed cargo units which are abutting each other on all sides. Too tightly packed cargo units or squeezing of cargo units and/or breaking of any part may be detected in the vibration data.

Vibration may be caused in many different ways. Vibration may be generated by a device, such as a vibration sensor, or the vibration may be caused by the environment. Vibration may be caused by a handling device, a movement, a motor, or any other part or device that causes vibration. At handling, loading and unloading stages, the handling devices cause vibration in the transport unit and the cargo. For example during loading or unloading by a forklift, vibration is caused when the forklift is driven into and out of the transport unit. An uneven floor level in the handling area may play at least some part in causing vibration, and it may be a feature designed for this purpose locally. A part of the floor in the handling area may be uneven in order to cause a given amount and type of vibration in a given situation. For example, handling, unloading or loading may be performed on a given unlevelled surface area, to know the vibration level when moving cargo with a given handling device. Deviations may be detected from the vibration data, and the system may analyze possible reasons for the deviations and generate proposals for remedying measures.

The condition of a loading environment or, for example, a storage may be inspected and monitored in a corresponding way as a transport unit/cargo. For example, the dirtiness or humidity of the loading environment may affect safety. The conditions in the environment of the handling area and the loading area may change, and for example changes or events in the outdoor environment are not always controllable. Their effect may be detected as well and thus be taken into account at inspection points, by means of inspection devices. The larger or heavier the product to be transported, the larger the devices and the greater the forces are needed for handling and transferring it. Benefits are brought by inspecting and monitoring the handling area and the loading environment, particularly in the case of large and heavy cargo units.

A maximum allowable weight may be defined for the transport unit and its cargo. For example, containers to be shipped may be weighed. In addition, there may be defined limit values for the weight distribution of the cargo of the transport unit. The weight and the weight distribution may be measured before the transportation. By means of vibration data, it is possible to measure the weight and the weight distribution of the loaded transport unit. Transport units having different weights vibrate in different ways. Also, the weight distribution of the transport unit may be verified from the vibration data, for example from vibration data measured from different points of the transport unit. By analyzing the vibration data it is possible to detect if the allowable weight of the cargo is exceeded. By means of the vibration data it is possible to determine the weight of the loaded transport unit and/or its cargo. By means of the vibration data it is possible to determine the weight distribution, for example the weight at a given point, the weight in a given span, the location of the mass centre, or in another way. On the basis of the analyzed vibration data, it is possible to classify said cargo or transport unit as acceptable or unacceptable for transportation. On the basis of the vibration data measured from the loaded transport unit, the learning system may detect unallowable weight or weight distribution values. The learning system utilizes artificial intelligence, and it is configured to learn on the basis of the entries made in it and the analyses made by it. On the basis of measurement history and other entries made and information available, the learning system may learn to detect cargo specific weight distributions, weights, and the weight of the transport unit. The learning system will learn that the vibration data entered in it is associated with a given weight for a given type of container. After receiving a new entry, the learning system compares different items of data and searches for correlations between the entry and the available data. The learning system detects relevant correlations which may be associated with e.g. frequency, area, container type, a ratio between some factors, or any data available. On the basis of the analysis, the learning system may identify an entry that was previously unknown to it. The weight and the weight distribution may be inspected during loading of the transport unit. Image data and vibration data may be combined for inspecting the weight and the weight distribution. The means for inspecting the weight and the weight distribution, such as the vibration and imaging devices, may be attached to the transport unit, the handling device, and/or the handling area.

### Learning System

The learning system may comprise a processing device, software, program means, a computer, a processing unit. The learning system may process and analyze inspection data programmably. The inspection data may be stored in various data structures, such as databases. The inspection data is available and usable in real time at the place of loading or unloading the cargo, in one or more handling areas, at different inspection points and/or inspection areas. Furthermore, the inspection data in different presentation modes may be accessible to a dispatcher, a recipient, a packer, a loader, an unloader, a driver, and other parties. Data on different means of transportation, handling devices, transport alternatives between the place of departure and the destination, clients, cargo types, and other relevant parties and factors relating to the transport are available to the learning system. The learning system has information or access to information on dates, seasons, conditions.

Reference values or models may be available to the learning system, for analyzing and handling of data, for example for identifying odours. The learning system may be applied for creating and/or developing models and certificates. Digital data may be processed, for example classified. The digital data is processed by the learning system. Program means for data processing may comprise pattern recognition and learning. For example, an algorithm may be used to recognize that measured data is associated with a given class, a given place or situation. The learning system may utilize artificial intelligence, neuro networks, multi-layer perception (MLP), general regression neural network (GRNN), fuzzy interference system (FIS), neuro fuzzy systems (NFS), or cluster analysis. In cluster analysis, the closest known reference having corresponding properties is searched for. The cluster analysis may be multidimensional, whereby different features may be examined at the same time, depending on each other and/or independently from each other.

The learning system may be a learning system that utilizes artificial intelligence. The learning system may record entries, the properties associated with them, and feedback given by users, recipients and other parties. For example, image data may be forwarded as raw data to be processed by the artificial intelligence. The image data may be forwarded to a machine vision application which may identify features, such as colour, height, shapes, vibration, or elements of these, vibration patterns, vector patterns, and so on. The features identified by the machine vision application may be forwarded further to be processed by an artificial intelligence.

The learning system is configured to learn by means of available data. The learning system may utilize partial data or crushed data, calculate probabilities and utilize data in a multidimensional way. By means of the artificial intelligence, the raw data or processed data or mined data may be stored as part of the learning system, in a given format with analyses. By means of the artificial intelligence and/or the learning system, an entry of a novel type may also be identified, for example at a given probability. The artificial intelligence makes it possible to utilize and apply big data.

Upon cargo shipping, data about the schedule, the freight, the place of departure and the destination may be recorded in a memory or as an entry in the learning system. The learning system will utilize all the stored data and information accessible to it. The learning system processes big data and searches for various correlations in the available data. By means of the learning system, it is possible to determine, for example, a route suitable for exactly this time of year and this schedule, for transporting the cargo from the place of departure to the destination. The learning system produces proposals, instructions and solutions, taking into account a number of correlating factors and their relations. The available data and information which may be taken into account when generating proposals, may include cargo data, such as cargo type, freight quantity, means of transportation alternatives, processing device alternatives, and history data, location of the handling area, location of the place of departure, location of the destination, season, weekday, month, time, available route, cargo packaging method, weather history, weather forecast, and so on. The condition of the loading environment, such as dirtiness, humidity and/or conditions, may be taken into account by the learning system. For example the season or ocean weather may influence the selection of the route. The learning system may propose a loading method and relating measures on the basis of the cargo type and the means of transportation. The learning system may generate and propose a loading order, a handling device, loading instructions, instructions for lashing the cargo, instructions for preparing the transport unit, placing the cargo units in the transport unit, a number of cargo units per transport unit, a means of transportation, a route, etc. The proposed items may correlate with each other directly or indirectly or not at all, and the learning system may take the correlations and their effects into account in the proposals. For example, sea transport may require stronger lashing than land transport. The cargo type and its properties may affect the need of lashing. Furthermore, the stored specifications/classifications, relating to e.g. information on unacceptable odours indicated by the recipient or defined for the receiving area, are taken into account when proposing actions, routes and devices.

In the analysis and generation of proposals by the learning system, it is possible to take into account odour data, such as the odour of the means of transportation when empty, the characteristic odour of the cargo, the state of protective gas for the cargo, and/or changes detected in these. Using the learning system, it is possible to take into account vibration data, such as handling forces, single damage faults, pressing force, shape of cargo, and/or changes detected in these. It is possible to compare e.g. transport, transport vehicle or route alternatives on the basis of the data available, when e.g. the handling devices, cargo type, cargo properties, departure location, destination, actors, time span, date, seasons are known. From these, it is possible to propose an optimal shipping date, method of shipping, route and carrier/actor in such a way that the cargo will be intact, in time, in acceptable condition at the destination.

The learning system has access to information and data relating to means of transportation, transport units, handling devices, cargo types, routes, and other factors mentioned above. Inspection devices are used to produce data, such as image, vibration, odour data. Data produced by mining enables planning and optimizing logistics, including routes and devices, as presented above, according to the situation and requirements at hand, and/or with respect to the relevant factors and their mutual correlations. For example, the system may produce an optimal way, including route, devices, quantity, time, and other details for transporting a given type of cargo to a given destination. Information may be mined from the big data for other purposes as well, such as statistical data relating to stages, devices, parties, and other factors. The data may be utilized by, for example, purchasers, holders, owners, insurers, and other parties in interest.

According to an aspect of the disclosed embodiments, the method for inspecting a transport unit and its cargo comprises producing image data by a camera, producing vibration data by a vibration sensor, producing odour data by an electronic nose, analysing image data, vibration data and odour data by software, and on the basis of the analysis, producing real-time information which is available in real time at the place of departure and at the destination of the cargo. The real-time information may be available for utilization at the planning of the handling and transportation stages of the transport unit and its cargo. Image data, vibration data and odour data may be detected at the handling stages, which are used to produce real-time feedback relating to said handling stage on the basis of the image data, vibration data and odour data. Image data, vibration data and odour data on at least one of the following may be detected and analyzed: an empty transport unit, a prepared transport unit, a loaded transport unit, cargo of a transport unit, stored transport unit, cargo of a stored transport unit, transported transport unit. Image data, vibration data and odour data may be detected and analyzed in at least one of the following stages: preparation of the transport unit, loading of the transport unit, unloading of the transport unit, transfer of the transport unit. In the method it is possible to analyze image data, vibration data and odour data by software which learns from the data received by it and from the analyses carried out by it, and utilizes the learning in analysis and feedback. Real-time data produced on the basis of the analysis may be available at an intermediate storage of the cargo. Data may be input in the software, optionally at the place of departure, at the destination or at an intermediate storage of the cargo, where the input data is available in real time at the place of departure and the destination of the cargo, and is available for utilization for analysis.

In an aspect of the disclosed embodiments, the apparatus for inspecting a transport unit and its cargo comprises a camera for producing image data, a vibration sensor for producing vibration data, an electronic nose for producing odour data, program means for analyzing image data, vibration data and odour data, and program means for producing real-time information on the basis of the analysis, and program means for making the real-time information available in real time at a place of departure and destination of the cargo. The apparatus may also comprise means for implementing any of the methods described above. In an aspect of the invention, the programmable device comprises a memory unit for storing data and program instructions, and a processing unit for analyzing the produced image data, vibration data and odour data, for producing real-time information on the basis of the analysis, and for making the real-time information available in real time at the place of departure and destination of the cargo.

Stored and available data may be presented to a user. The user may be the owner of the cargo, the recipient of the cargo, an insurer, a carrier, a loader, or another party. An interactive view with image data may be produced for the user. Storing the data makes it possible to create a 3D pattern of the data. In this way, the user is given a graphic 3D presentation of the inspected object. The visual part may comprise a 3D model of the transport unit, which the user may examine three-dimensionally on a display or in a virtual view. The visual presentation may be supplemented with information on other inspection data, for example weight distribution detected on the basis of vibration. The cargo type, properties of the cargo, the cargo identification data, the cargo order, the placement of the cargo, possible gaps between cargo units, the loading order, the unloading order, the condition of the cargo, possible damages in packing, possible deformations in the cargo or packing, dirtiness of the cargo, success in loading, other cargo information detected or deviating from the normal, condition of the transport unit, such as dirtiness or damage, route of the transport unit, may be presented to the user. All this information and previously stored inspection data are available for the software.

### Handling, Loading, Unloading

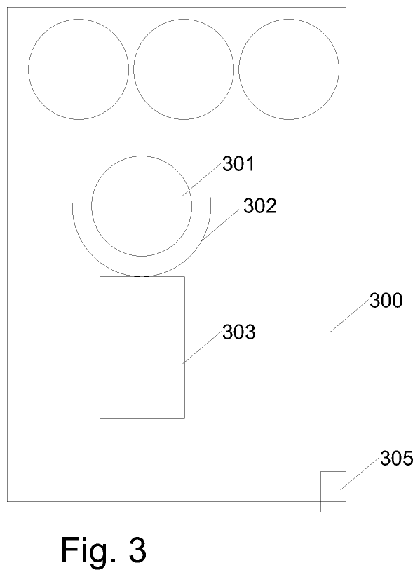

FIG. 3 shows loading of cargo into a transport unit according to an embodiment. The cargo unit 301 may be a package unit or a reel. The package unit or reel may be loaded into a container 300 which is transferred on board a ship, a train or a trailer truck for transportation. The package unit or reel 301 is loaded into a container by e.g. a forklift 303. During the loading, the inspection devices may be placed in the handling area, the storage, the transport unit, or the handling device, such as the forklift. In FIG. 3, an inspection device 305 is placed in the transport unit. The inspection device 305 may be camera shooting in two directions, or a movable camera for shooting the cargo unit 301 and the forklift 303 when the forklift is driven towards the transport unit 300 and when the forklift 303 is in the transport unit 300. The inspection device may be a portable device which is carried and used by a user, or which may be attached to a given location by e.g. a magnet. The inspection device may be a camera for producing image data, a vibration sensor for producing vibration data, or an electronic nose for producing odour data. The inspection device may be attached to e.g. the fork or the gripper 302 of the forklift. By means of the inspection devices, information is obtained during the handling, loading and unloading of cargo. On the basis of the information available, the processing device or software may produce a proposal for measures relating to the handling, loading and/or unloading of the cargo, the devices and methods to be used therein. Real-time inspection data may be used to monitor the handling/loading/unloading in real time and to indicate changes immediately during the handling/loading/unloading. The processing device or software may be used to produce proposals for remedying the situation, as presented above.

Image data from the camera and data from the vibration sensor may be used to monitor, for example, the driving speed of the forklift 303 into and out of the container 300, as well as the realization of the freighting plan, such as the placement of package units or reels. The path of the forklift 303 is observed, and the cycles (in and out) driven by the forklift may be used to estimate the loading time and the progress of the loading, the loading percentage. The image data may be used to detect the locations of straps, protective papers and other means placed at the preparation stage, during handling, before loading, during loading, after loading, before unloading, during unloading, and after unloading.

Image data and vibration data as well as possible odour data, detected during the handling, loading and unloading of cargo, support each other and make it possible to monitor the handling/loading/unloading. The inspection devices may be used to monitor the condition of the cargo and to measure handling forces. When the forklift 303 or another handling device is driven into the container 300, it causes vibration in the container 300, which may be measured. If a momentary increase in the vibration strength, a peak in the vibration data, is detected, it is possible to examine the image data stored at that moment, such as a series of images or video, in more detail. When there is a lot of image data, its examination may be prioritized on the basis of vibration data. In this way, relevant image data may be found and examined in detail, and it will not be necessary to allocate processing capacity for examining all the image data. Gases emanating from cargo units are detected by an electronic nose. The vibration data, image data and possible odour data are transmitted to the processing device or software which analyzes them by means of e.g. artificial intelligence. The processing device or software produces information about the condition of the cargo, the stage and quality of loading. The handling, loading and unloading stages may be documented, for example in a report, by means of the detected data. The report may contain image data on the empty transport unit, the handling stages, the possibly prepared container, the loading stages, the unloading stages, and the loaded cargo units. The report may indicate the cleanliness of the transport unit; the cleanliness of the handling area; the quality of the preparation of the transport unit; the loading order; the quality of loading, handling and unloading, including the handling forces; the placement of the cargo; the order of cargo units; the lashing of the cargo; the condition of the cargo unit; data on a possible preceding handling stage; and/or changes in these. These may be compared with a generated proposal or plan.

The inspection device 305 may comprise a movable camera or two cameras for shooting in two different directions: to the inside of the container, and from the door opening of the container outwards. The camera 305 may be used to capture each package unit or reel 303 when it is brought into the container. The cameras 305 are used to capture a package unit or reel in a front view when it is being moved into the container 300 and in a rear view after it has been placed in the container 300. In this way, at least two sides of each package unit or reel 301 may be imaged. The handling device may comprise one or more cameras to supplement the overall picture of the package unit or reel. For example, a camera (cameras) may be provided in the grippers 302 of the forklift. In this way, the package unit or reel may be imaged from all sides.

Cargo damage incurred during handling, loading or unloading may be detected by means of the image data. Damage in the package unit or reel may be detected in the image data produced by the cameras. For example, the driver of the forklift does not necessarily detect damage in a cargo unit, such as a package unit or reel. The images taken by the camera 305 from two directions may provide image data in which the damage of the cargo unit may be detected. A component to facilitate the detection may be included below the surface material of the packing of the cargo unit. A material which is exposed and is detected after damage to the surface material, may be provided below the surface material. In this way, it is possible to facilitate the detection of damage. For example, a chemical which reacts with oxygen, is coloured or reflects a certain type of light after reacting with oxygen, facilitates the detection of damage in image data. As information on a damaged package unit or reel is immediately obtained from the inspection device, the damaged cargo unit may be removed from the transport unit and it will not be left as part of the cargo, nor will the damaged package unit or reel be transported to the destination. This has a positive effect on the quality of the cargo and the efficiency of the transportation.

Damage to a cargo unit during handling, loading, unloading, or another work stage may be detected by the inspection devices. For example, a forklift 303 may collide with and damage a package unit or reel that has already been packed. The collision may be detected as a momentary change in the vibration strength by a vibration sensor. This leaves an indication of possible damage to the package unit or reel. On the basis of the detected change in the vibration strength, the driver of the forklift may be given an instruction to check the damaged package unit or reel, to remove it, or to decrease the loading speed. The driving speed into and out of the container is detected from the vibration data and/or the image data. The driver of the forklift may be instructed to decrease the speed.

A cargo unit 301 may be brought too close to another cargo unit by the forklift 303. Thus the fork or gripper 302 of the forklift may damage the other package unit or reel already in place in the container, when the next package unit or reel, brought too close, is being lowered down. This may be detected from the image data and/or the vibration data. If the package unit or reel has a gas wrapping, damaging it will release gas which may be detected by an electronic nose. If the reels are packed too tightly or they are pressed too strongly by the handling device, the core in the center of the reel, keeping the reel in shape, may be damaged. This causes vibration which may be detected by a vibration sensor at the time of the change or later on. On the basis of the detection, a reel broken during loading may be immediately indicated to the driver of the forklift, who may remove it from the container.

The camera may be used to examine shapes, such as the roundness of a reel. Reels may be loaded too tightly against each other, whereby they may be deformed. The roundness of a reel may be monitored in image data with the help of, for example, a surface pattern or text on the reel. If discontinuity in the surface pattern is detected in the image data, it is possible to indicate damage to the reel, a deviation of its shape from the round shape, becoming more oval. When a round reel becomes oval, parts of the reel become denser than originally. Reels with varying density vibrate in a different way than original reels with a relatively constant density. Ovality or another deformation of the reel may be detected as a change in the vibration data. In response to the detection, feedback is generated in real time. For example, an incorrect pressing force caused on the reels during loading is indicated to the loader.

Instructions for the handling, loading and/or unloading stage may be generated in real time. The software may monitor the progress of the plan and possible parameters set, such as driving speeds or handling strengths. A handling strength may relate to the speed or direction of a handling device, a change in the speed or direction, a collision of the handling device with cargo or the transport unit, a collision of the cargo unit with other cargo or the means of transportation or another obstacle. Monitoring the handling strength makes it possible to detect changes or peaks, to analyze data, and to give real-time feedback and respective instructions to the handling person.

In an aspect of the invention, a monitoring/inspecting device based on vibration data and image data may be produced for the cargo handling, loading and unloading stages. Odour data may be taken into account as well. A stage may be designed by software, and/or its progress may be monitored in real time. The software may also propose remedying measures in real time on the basis of inspection data and analyses. For example, it is possible to examine driving speed, driving path, pressing force, lifting force, loading order, placement of cargo, space left between cargo units, lashing, preparations and corresponding factors during handling, loading and/or unloading; and to generate real-time instructions for the handling, loading and/or unloading stages on the basis of detected data. Software may be used to control the handling to reduce damage to cargo. The handling, loading and unloading stages may be optimized according to e.g. the cargo type, cargo quantity and the handling device.

By means of the aspects of the invention, it is possible to inspect and monitor transport units, their handling, and the cargo transported in them automatically and in real time at different stages of transportation. The inspections enable inspection, examination and monitoring of the condition anywhere in real time on the basis of the data produced. The inspection data and its handling enable giving immediate feedback, for example at the time of detecting damage. This, in turn, makes it possible to address the situation immediately. On the basis of the inspection data and other data, the transportation process and its stages may be optimized. Instructions and guidelines for the parties involved may be produced in real time. This improves the quality of the cargo as well as the efficiency of the transportation.

Some aspects and examples of the disclosed embodiments have been presented above. The presented features, methods and details may be combined, exchanged, replaced, and deleted without deviating from the scope of protection of the present disclosure. The scope of protection of the invention is not limited solely to that presented above.

1. A method for inspecting cargo during handling, loading or unloading, wherein
the cargo is inspected when cargo units are being handled, loaded into a transport unit or unloaded from a transport unit;
the cargo is inspected with aid of image data produced on the cargo and the transport unit;
the cargo is inspected with aid of vibration data produced on the cargo and the transport unit; and
the image data and the vibration data are analyzed, and on the basis of the analysis, information and feedback is produced in real time.

2. The method according to claim 1, wherein the cargo is inspected with aid of a camera and a vibration sensor attached to the transport unit.

3. The method according to claim 1, wherein the cargo is inspected with aid of a camera and a vibration sensor attached to the transport unit, wherein with aid of image data and/or vibration data, possible cargo damage during handling, loading or unloading is detected.

4. The method according to claim 1, wherein the cargo is inspected with aid of a camera attached to a cargo handling device, and image data is produced on the cargo handled by the handling device, on the transport unit, and/or on the environment.

5. The method according to claim 1, wherein the handling, loading and/or unloading of cargo causes vibration which is detected with aid of the vibration sensor, and which vibration data is analyzed for producing information on the cargo.

6. The method according to claim 1, wherein damage caused to the cargo during handling, loading and/or loading of the cargo is detected with aid of image data and/or vibration data in real time, and loading the damaged cargo to be moved to the transport unit is prevented.

7. The method according to claim 1, wherein the degree of readiness of loading or unloading is verified with aid of image data and/or vibration data in real time.

8. The method according to claim 1, wherein cargo packings are equipped with identifications, with aid of which their integrity or damage is detectable in image data.

9. The method according to claim 1, wherein the shape of the cargo unit or a part of it is analyzable with aid of image data and/or vibration data, and any deformation of the shape is detected and subjected to feedback with a possible proposal for remedying action.

10. The method according to claim 1, wherein on the basis of the analysis, information and feedback is generated in real time on at least one of the following: cargo handling strength, driving speed of the handling device, driving path into and out of the transport unit, pressing force exerted on the cargo by the handling device, lifting force exerted on the cargo by the handling device, loading order, placement of cargo units, lashing of the cargo, predicted rejection of the cargo, and grounds for the rejection.

11. The method according to claim 1, wherein on the basis of the analysis, instructions on work stages for handling, loading and/or unloading are generated.

12. The method according to claim 1, wherein on the basis of the analysis, information on the lashing of the cargo is produced, which information is optionally related to at least one of the following: cargo type, route, means of transportation, handling device, season, location, weekday, month, time, packaging method, weather conditions, history data, recipient.

13. The method according to claim 1, wherein the vibration sensor detects vibration in three different directions.

14. The method according to claim 1, wherein on the basis of the analysis, real-time information and feedback is generated on at least one of the following: handling strength, speed of the handling device or variation thereof, direction of the handling device or variation thereof, collision of the handling device with the cargo or the transport unit, collision of the cargo unit with the cargo or the transport unit or an obstacle.

15. The method according to claim 1, wherein by analyzing vibration data, real-time information is provided on at least one of the following: condition of the cargo, lashing of the cargo, preparation of the transport unit, condition of the transport unit, strength of handling the cargo, weight of the cargo placed in the transport unit, and weight distribution of the cargo.

16. An apparatus inspect configured to inspect cargo during handling, loading or unloading, the apparatus comprising
a camera configured to produce image data on cargo,
a vibration sensor configured to analyze the image data on cargo, and
a processable program configured to analyze the image data and the vibration data and to produce real-time information and feedback on the basis of the analysis.

17. (canceled)

18. Learning program configured to process cargo inspection data, comprising a processing unit and
program configured to analyze image data,
program configured to analyze vibration data, and
program configured to produce real-time information and feedback on the basis of the analysis.
